(19) United States
(12) Patent Application Publication
(10) Pub. No.: US 2013/0322492 A1
(43) Pub. Date: Dec. 5, 2013

(54) Device and Method for Measuring an Extremal Temperature

(71) Applicant: Stefan Butzmann, Beilstein (DE)

(72) Inventor: Stefan Butzmann, Beilstein (DE)

(73) Assignees: Samsung SDI Co., Ltd., Yongin-si, Gyeonggi-do (KR); Robert Bosch GmbH, Syuttgart (DE)

(21) Appl. No.: 13/992,735

(22) PCT Filed: Oct. 26, 2011
(86) PCT No.: PCT/EP11/68692

§ 371 Date: Aug. 16, 2013

(30) Foreign Application Priority Data
Dec. 10, 2010 (DE) 10 2010 062 844.1

(51) Int. Cl. G01K 7/00

(52) U.S. Cl. CPC G01K 7/00
USPC 374/183; 374/100; 374/163

(57) ABSTRACT

The disclosure relates to a device for measuring an extremal temperature among temperatures of a plurality of temperature sensors. A first temperature sensor is configured to conduct a current that corresponds to the temperature of the sensor, and each (k+1)th temperature sensor is equipped to conduct the larger of two currents, that is, a current that corresponds to the temperature of the respective sensor and the current that the kth temperature sensor conducts. The disclosure further relates to a battery management system that includes a device according to the disclosure, to a battery comprising a device according to the disclosure or a battery management system according to the disclosure, to a motor vehicle including a battery according to the disclosure, and to a method for measuring the extremal temperature among a plurality of temperatures

The present invention relates to an apparatus and a method for measuring an extremal temperature among a multiplicity of temperatures, and particularly to an apparatus for measuring the maximum temperature among the temperatures of the battery cells in a battery, and also to a battery management system having such an apparatus, to a battery having such an apparatus or such a battery management system and to a motor vehicle having such a battery.

### PRIOR ART

It is apparent that in future both static applications (e.g. wind power installations) and vehicles such as hybrid and electric vehicles will make increasing use of new battery systems on which very high demands in terms of reliability are placed. The background to these high demands is that failure of the battery can result in failure of the whole system or even in a safety-related problem. Thus, wind power installations, for example, use batteries to protect the installation from inadmissible operating states in a high wind by means of rotor blade adjustment.

Typically, lithium ion batteries today involve the voltage of each cell being monitored individually. This is accomplished by clustering the individual cells to form modules and using a monitoring unit in the form of an integrated circuit that measures the cell voltages and uses a communication bus to send them to a central control unit, which calculates the state (charge state, aging, . . . ) of the individual cells therefrom. At the same time, temperature sensors are usually fitted on a plurality of cells within a battery line in order to monitor the temperature of the cells. In this case, it is of particular importance that none of the cells exceeds a particular maximum temperature.

Typically, the temperature sensors used are NTC thermistors, that is to say negative temperature coefficient resistors (NTC resistors). In this case, the temperature coefficient indicates the relative change in the electrical resistance with the temperature, that is to say that with a negative temperature coefficient the resistance falls as temperature rises.

FIG. 1 shows a circuit diagram of an apparatus for measuring the temperatures of battery cells 11-1, . . . , 11-n in a battery 10 based on the prior art. The temperatures of the series-connected battery cells 11-1, . . . , 11-n are in each case measured using voltage dividers 12-1, . . . , 12-n, which in each case comprise a fixed resistor 13-1, . . . , 13-n and a negative temperature coefficient resistor 14-1, . . . , 14-n, the negative temperature coefficient resistor 14-1, . . . , 14-n in each case being fitted on the battery cell 11-1, . . . , 11-n, with the result that it is at essentially the same temperature as this. Analog-to-digital converters 15-1, . . . 15-n in each case measure the division ratios that the voltage dividers 12-1, . . . , 12-n use to divide the applied voltages 16-1, . . . , 16-n, and output appropriate digital signals 17-1, . . . , 17-n, from which it is possible in each case to infer the temperatures of the negative temperature coefficient resistors 14-1, . . . , 14-n, and hence those of the battery cells 11-1, . . . , 11-n.

In order to determine the maximum temperature among the temperatures of the battery cells 11-1, . . . , 11-n, this apparatus based on the prior art thus requires analog-to-digital conversion of the temperature-dependent signals with subsequent digital comparison of the temperature values in order to ascertain the maximum temperature.

### DISCLOSURE OF THE INVENTION

The invention provides an apparatus for measuring the extremal temperature among the temperatures from a multiplicity of temperature sensors, wherein a first temperature sensor is designed to carry a current that corresponds to its temperature, and the (k+1)-th temperature sensor is in each case designed to carry the larger of a current that corresponds to its temperature and the current that the k-th temperature sensor carries.

Here and subsequently, the integer k in each case passes through all values from 1 to a maximum value, the maximum value being one less than the number of temperature sensors in the case of statements which contain the expression k+1, and the maximum value being equal to the number of temperature sensors in the case of statements which contain only the number k and not the expression k+1.

The extremal temperature may be either the maximum temperature or the minimum temperature. The relationship between currents and temperatures is the same for all temperature sensors.

In one preferred embodiment of the invention, the extremal temperature is the maximum temperature, and the temperature sensors are in each case negative temperature coefficient resistors. Preferably, the temperature dependency R(T) of the electrical resistance of the temperature sensors is the same in each case for all temperature sensors. In this case, the choice of a reference voltage U_{Ref} for all temperature sensors on the basis of the equation I=U_{Ref}/R(T) allows the same relationship between temperature and current to be produced. In principle, however, it is also possible to use different temperature dependencies of the electrical resistor and different reference voltages for all temperature sensors to produce the same relationship between temperature and current.

Preferably, the apparatus also comprises a multiplicity of first amplifier circuits, wherein each of the first amplifier circuits has a first input, a second input and an output and is designed such that a current from the second input to the output appears such that the electrical potential of the first input is at least equal to the electrical potential of the second input. In this case, the number of first amplifier circuits is preferably equal to the number of temperature sensors.

Preferably, the apparatus also comprises a multiplicity of second amplifier circuits, wherein each of the second amplifier circuits has a first input, a second input and an output and is designed such that a current from the output to the second input appears such that the electrical potential of the second input is at least equal to the electrical potential of the first input. In this case, the number of second amplifier circuits is preferably one less than the number of temperature sensors. If only two temperature sensors are provided, the apparatus thus preferably comprises only one second amplifier circuit instead of a multiplicity of second amplifier circuits.

In one preferred embodiment, each of the amplifier circuits comprises an operational amplifier and a transistor, wherein in each case the noninverting input of the operational amplifier forms the first input of the amplifier circuit, the inverting input of the operational amplifier forms the second input of the amplifier circuit, a first connection of the transistor is connected to the second input of the amplifier circuit, a second connection of the transistor forms the output of the amplifier circuit and the control connection of the transistor is connected to the output of the operational amplifier.

The apparatus may comprise a multiplicity of reference voltage sources, wherein preferably all reference voltage sources in each case provide the same reference voltage.

In one preferred embodiment of the invention, the first input of the k-th first amplifier circuit is in each case connected to a first connection of the k-th reference voltage source, the second input of the k-th first amplifier circuit is in each case connected to a first connection of the k-th temperature sensor, a second connection of the first temperature sensor is connected to a second connection of the first reference voltage source, a second connection of the (k+1)-th temperature sensor is in each case connected to the output of the k-th first amplifier circuit and to the second input of the k-th second amplifier circuit and the second connection of the (k+1)-th reference voltage source is in each case connected to the first input of the k-th second amplifier circuit.

Preferably, the temperature sensors are in each case fitted on the battery cells of a battery line in a battery. In this case, a battery line is intended to be understood to mean a multiplicity of battery cells connected in series. Preferably, the battery is a lithium ion battery.

In one preferred embodiment of the invention, the first connection of the k-th reference voltage source and the first input of the k-th first amplifier circuit are in each case connected to the negative pole of the k-th battery cell, and the positive pole of the (k+1)-th battery cell is in each case connected to the output of the k-th second amplifier circuit.

The invention also provides a battery management system having an apparatus according to the invention, a battery having an apparatus according to the invention or a battery management system according to the invention and also a motor vehicle, particularly an electric motor vehicle, having a battery according to the invention.

In addition, the invention provides a method for measuring the extremal temperature among a multiplicity of temperatures, wherein a first current that corresponds to a first temperature is brought about, and further currents are brought about, wherein in each case the (k+1)-th current is the larger of the k-th current and a current that corresponds to the (k+1)-th temperature.

### DRAWINGS

An exemplary embodiment of the invention is explained in more detail using the description below and with reference to the drawings, in which:

FIG. 1 shows a circuit diagram of an apparatus for measuring the temperatures of battery cells in a battery based on the prior art, and

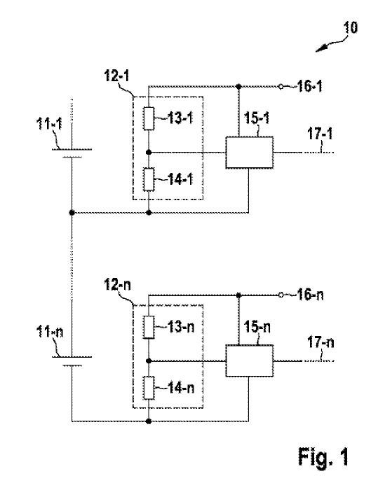

FIG. 2 shows a circuit diagram of an apparatus according to the invention for measuring the maximum temperature among the temperatures of the battery cells in a battery.

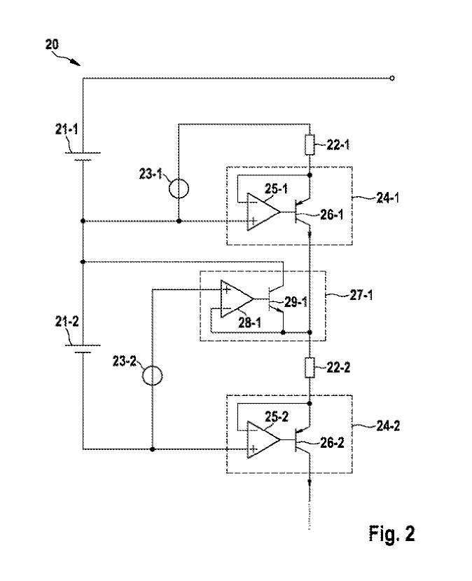

The battery 20 shown in FIG. 2 comprises a battery line comprising battery cells 21-1, 21-2, . . . , which are connected in series. The battery cells 21-1, 21-2, . . . for which the temperature is intended to be sensed have in each case NTC thermistors 22-1, 22-2, . . . fitted on them as temperature sensors, said NTC thermistors in each case being supplied with current by reference voltage sources 23-1, 23-2, . . . . The NTC thermistors 22-1, 22-2, . . . in each case have the same temperature dependency R(T) of the electrical resistance. The reference voltage sources 23-1, 23-2, . . . in each case provide the same reference voltage U_{Ref}. In this case, a first connection of the reference voltage sources 23-1, 23-2, . . . is in each case connected to the negative pole of the relevant battery cell 21-1, 21-2, . . . . A first connection of the NTC thermistors 22-1, 22-2, . . . is in each case held dynamically at the electrical potential of the negative pole of the associated battery cell 21-1, 21-2, . . . by means of an amplifier circuit 24-1, 24-2, . . . .

The amplifier circuits 24-1, 24-2, . . . in each case comprise an operational amplifier 25-1, 25-2, . . . and a pnp transistor 26-1, 26-2, . . . , which are connected up in a negative feedback loop such that the current from the emitter to the collector of the pnp transistor 26-1, 26-2, . . . in each case appears such that the electrical potential of the noninverting input of the operational amplifier 25-1, 25-2, . . . is in each case at least equal to the electrical potential of the inverting input of the operational amplifier 25-1, 25-2, . . . . Since the pnp transistors 26-1, 26-2, . . . are not off during operation of the circuit, the two inputs of the operational amplifiers 25-1, 25-2, . . . are in each case held at the same electrical potential.

The noninverting input of the operational amplifiers 25-1, 25-2, . . . is in each case connected to the negative pole of the relevant battery cell 21-1, 21-2, . . . and also to the first connection of the relevant reference voltage source 23-1, 23-2, . . . . The inverting input of the operational amplifiers 25-1, 25-2, . . . is in each case connected to the first connection of the relevant NTC thermistor 22-1, 22-2, . . . .

A second connection of the first reference voltage source 23-1 is connected to a second connection of the first NTC thermistor 22-1. Accordingly, a current I_{I}=U_{Ref}/R₁ flows through the NTC thermistor 22-1, where R₁ denotes the temperature-dependent electrical resistance of the NTC thermistor 22-1. Since a second connection of the remaining NTC thermistors 22-2, . . . is in each case connected to the output of the preceding first amplifier circuit 24-1, 24-2, . . . , this current is forwarded to the next NTC thermistor 22-2 by the pnp transistor 26-1.

The crucial aspect now is that the second connection of the remaining NTC thermistors 22-2, . . . is furthermore in each case connected to the second input of a further amplifier circuit 27-1, . . . . These further amplifier circuits 27-1, . . . in each case comprise an operational amplifier 28-1, . . . and an npn transistor 29-1, . . . , which are connected up in a negative feedback loop such that the current from the collector to the emitter of the npn transistor 29-1, . . . in each case appears such that the electrical potential of the inverting input of the operational amplifier 28-1, . . . is in each case at least equal to the electrical potential of the noninverting input of the operational amplifier 28-1, . . . .

Depending on the temperatures and hence the electrical resistances of the two NTC thermistors 22-1 and 22-2, two cases can now be distinguished. If the temperature of the battery cell 21-1, and hence that of the NTC thermistor 22-1, is higher than the temperature of the battery cell 21-2, and hence that of the NTC thermistor 22-2, then the electrical resistance of the NTC thermistor 22-1, R₁, is lower than the electrical resistance of the NTC thermistor 22-2, R₂. In this case, the current I₁ via the NTC thermistor 22-2 and the pnp transistor 26-2 continues to flow downward. In this case, the voltage across the NTC thermistor 22-2 is higher than the reference voltage U_{Ref}. Therefore, the npn transistor 29-1 is off and does not supply any additional current to the NTC thermistor 22-2, as a result of which the current I₂ that flows through the NTC thermistor 22-2 is in this case equal to the current I₁ that flows through the NTC thermistor 22-1.

If, by contrast, the temperature of the battery cell 21-1, and hence that of the NTC thermistor 22-1, is lower than the temperature of the battery cell 21-2, and hence that of the NTC thermistor 22-2, then the electrical resistance of the NTC thermistor 22-1, R₁, is higher than the electrical resistance of the NTC thermistor 22-2, R₂. In this case, the inverting input of the operational amplifier 28-1 would be at a lower electrical potential than the noninverting input of the operational amplifier 28-1 if just the current I₁ were to flow through the NTC thermistor 22-2. Therefore, in this case, so much current is additionally supplied to the NTC thermistor 22-2 via the npn transistor 29-1 that is not off that in turn the reference voltage U_{Ref} drops across the NTC thermistor 22-2 and the two inputs of the operational amplifier 28-1 are at the same electrical potential. The current I₂ through the NTC thermistor 22-2 and the pnp transistor 26-2 is I₂=U_{Ref}/R₂ in this case.

Overall, it thus holds that I₂=max (I₁, U_{Ref}/R₂), that is to say that the current I₂ corresponds to the higher of the two temperatures of the two NTC thermistors 22-1 and 22-2, and hence of the two battery cells 21-1 and 21-2.

A corresponding consideration shows that the current through each further NTC thermistor (not shown) is in each case either equal to the current through the preceding NTC thermistor or corresponds to the temperature of said further NTC thermistor. Complete induction means that this results in the current through each of the NTC thermistors 22-1, 22-2, . . . in each case corresponding to the maximum temperature among the temperatures of said NTC thermistor and all preceding NTC thermistors. In particular, it follows that the current through the last NTC thermistor in the chain corresponds to the maximum temperature among the temperatures of all the NTC thermistors, and hence to the sought maximum temperature among the temperatures of all the battery cells.

The principle of the invention has been presented above for the—in practice—particularly relevant case of determination of the maximum temperature among a multiplicity of temperatures. It goes without saying that this principle can likewise be applied to the case of determination of the minimum temperature among a multiplicity of temperatures by using PTC thermistors, that is to say positive temperature coefficient resistors (PTC resistors), instead of the NTC thermistors. In this case, the current through each of the PTC thermistors in each case corresponds to the minimum temperature among the temperatures of said PTC thermistor and of all preceding PTC thermistors, and the current through the last PTC thermistor in the chain corresponds to the minimum temperature among the temperatures of all the PTC thermistors.

It is likewise evident to a person skilled in the art that instead of the cascade beginning at one end of the battery line, appropriate reversal of the polarities of the operational amplifiers and transistors can likewise be used to set up a cascade beginning at the other end of the battery line, which ascertains a minimum or maximum temperature among a multiplicity of temperatures on the basis of the same principle.

The apparatus described above can be used as part of a battery management system that monitors the maximum temperature of the battery cells in a battery and protects the battery cells against overheating. Such a battery management system can be used as part of a battery, particularly a battery that is used in a motor vehicle.

1. An apparatus for measuring an extremal temperature of a plurality of temperatures comprising:
a plurality of temperature sensors configured to sense the plurality of temperatures, a first temperature sensor of the plurality of temperature sensors being configured to carry a first current that corresponds to a first temperature of the plurality of temperatures,
wherein a (k+1)-th temperature sensor of the plurality of temperature sensors is in each case configured to carry a larger of (i) a (k+1)-th current that corresponds to a (k+1)-th temperature of the plurality of temperatures, and (ii) a k-th current carried by a k-th temperature sensor of the plurality of temperature sensors.

2. The apparatus as claimed in claim 1, wherein:
the extremal temperature is a maximum temperature of the plurality of temperatures, and
the temperature sensors of the plurality of temperatures sensors are in each case negative temperature coefficient resistors.

3. The apparatus as claimed in claim 1, further comprising:
plurality of first amplifier circuits, each first amplifier circuit of the plurality of first amplifier circuits including a first input, a second input, and a first output, and each first amplifier circuit of the plurality of first amplifier circuits being configured such that an input current from the second input to the first output appears such that an electrical potential of the first input is at least equal to an electrical potential of the second input; and
a plurality of second amplifier circuits, each second amplifier circuit of the plurality of second amplifier circuits including a third input, a fourth input, and a second output, and each second amplifier circuit of the plurality of second amplifier circuits being configured such that an output current from the second output to the fourth input appears such that an electrical potential of the fourth input is at least equal to an electrical potential of the third input.

4. The apparatus as claimed in claim 3, wherein:
each first amplifier circuit of the plurality of first amplifier circuits and each second amplifier circuit of the plurality of second amplifier circuits includes an operational amplifier and a transistor,
in each case a noninverting input of the operational amplifier forms the first input of the first amplifier circuit and the third input of the second amplifier circuit, an inverting input of the operational amplifier forms the second input of the first amplifier circuit and the fourth input of the second amplifier circuit, a first connection of the transistor is connected to the second input of the first amplifier circuit and the fourth input of the second amplifier circuit, a second connection of the transistor forms the first output of the first amplifier circuit and the second output of the second amplifier circuit, and a control connection of the transistor is connected to an output of operational amplifier.

5. The apparatus as claimed in claim 4, further comprising:
plurality of reference voltage sources.

6. The apparatus as claimed in claim 5, wherein the first input of a k-th first amplifier circuit is in each case connected to a first connection of a k-th reference voltage source, the second input of the k-th first amplifier circuit is in each case connected to a first connection of the k-th temperature sensor, a second connection of the first temperature sensor is connected to a second connection of a first reference voltage source, a second connection of the (k+1)-th temperature sensor is in each case connected to the output of the k-th first amplifier circuit and to the second input of a k-th second amplifier circuit and a second connection of a (k+1)-th reference voltage source is in each case connected to the first input of the k-th second amplifier circuit.

7. The apparatus as claimed in claim 6, wherein the temperature sensors of the plurality of temperature sensors are in each case fitted on a battery cell of a plurality of battery cells of a battery line in a battery.

8. The apparatus as claimed in claim 7, wherein:
the first connection of the k-th reference voltage source of the plurality of reference voltage sources and the first input of the k-th first amplifier circuit of the plurality of first amplifier circuits are in each case connected to a negative pole of a k-th battery cell of the plurality of battery cells, and
a positive pole of a (k+1)-th battery cell of the plurality of battery cells is in each case connected to the output of the k-th second amplifier circuit of the plurality of second amplifier circuits.

9. The apparatus as claimed in claim 8, wherein the apparatus is included in a battery management system.

10. A battery comprising:
a battery management system including an apparatus for measuring an extremal temperature of a plurality of temperatures, the apparatus including a plurality of temperature sensors configured to sense the plurality of temperatures, a first temperature sensor of the plurality of temperature sensors being configured to carry a first current that corresponds to a first temperature of the plurality of temperatures,
wherein a (k+1)-th temperature sensor of the plurality of temperature sensors is in each case configured to carry a larger of (i) a (k+1)-th current that corresponds to a (k+1)-th temperature of the plurality of temperatures, and (ii) a k-th current carried by a k-th temperature sensor of the plurality of temperature sensors.

11. The battery as claimed in claim 10, wherein the battery is included in an electric motor vehicle.

12. A method for measuring an extremal temperature of a plurality of temperatures, comprising:
bringing about a first current of a plurality of currents, the first current corresponding to a first temperature of the plurality of temperatures; and
bringing about further currents of the plurality of currents,
wherein in each case a (k+1)-th current of the plurality of currents is a larger of (i) a k-th current of the plurality of currents, and (ii) a (k+1)-th current of the plurality of currents that corresponds to the (k+1)-th temperature of the plurality of temperatures.
